(19) United States
(12) Patent Application Publication
(10) Pub. No.: US 2017/0230932 A1
(43) Pub. Date: Aug. 10, 2017

(54) PAGING CONFLICT MANAGEMENT FOR MULTI-SIM WIRELESS COMMUNICATION DEVICE

(71) Applicant: QUALCOMM Incorporated, San DIego, CA (US)

(72) Inventors: Nikhil Challa, San Diego, CA (US); Anand Chowdhary Kolluri, San Diego, CA (US); Thiagarajan Sivanadyan, Boulder, CO (US); Chintan Shirish Shah, Chula Vista, CA (US)

(21) Appl. No.: 15/382,465

(22) Filed: Dec. 16, 2016

Related U.S. Application Data
(60) Provisional application No. 62/291,172, filed on Feb. 4, 2016.

(51) Int. Cl. H04W 68/02

(52) U.S. Cl. CPC H04W 68/02; H04W 88/06

(57) ABSTRACT

Embodiments described herein relate to apparatuses and methods for a wireless communication device having a first Subscriber Identity Module (SIM) associated with a first subscription and a second SIM associated with a second subscription to manage communications over the first subscription and the second subscription, including, but not limited to, determining valid paging occasions associated with the first subscription, determining a selected paging occasion of the valid paging occasions based on at least one of activities of the second subscription or a sleep period of the first subscription, and receiving a page of the first subscription on the selected paging occasion.

### CROSS-REFERENCE TO RELATED PATENT APPLICATIONS

This application claims priority from U.S. Provisional Application No. 62/291,172, filed Feb. 4, 2016, incorporated herein by reference in its entirety.

### BACKGROUND

A wireless communication device, such as a mobile phone device or a smart phone, may include two or more Subscriber Identity Modules (SIMs). Each SIM may correspond to at least one subscription via one or more Radio Access Technologies (RATs). Such a wireless communication device may be a multi-SIM wireless communication device. In a Multi-SIM-Multi-Active (MSMA) wireless communication device, all SIMs may be active at the same time. In a Multi-SIM-Multi-Standby (MSMS) wireless communication device, if any one SIM is active, then the rest of the SIM(s) may be in a standby mode. The RATs may include, but are not limited to, Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS), Wideband Code Division Multiple Access (WCDMA), Long Term Evolution (LTE), High-Speed Downlink Packet Access (HSDPA), and the like), Global System for Mobile Communications (GSM), Code Division Multiple Access 1× Radio Transmission Technology (1×), General Packet Radio Service (GPRS), Wi-Fi, Personal Communications Service (PCS), and other protocols that may be used in a wireless communications network or a data communications network.

A multi-SIM (e.g. MSMS) wireless communication device may have a first subscription enabled by a first SIM and a second subscription enabled by a second SIM. The first subscription may be connected to a Radio Resource Control (RRC) with active data transfer enabled. The second subscription may be in a RRC-idle state. When a paging occasion of the first subscription collides or overlaps with activities of the second subscription, the second subscription may have priority over the first subscription due to the second subscription being in the RRC-idle state. For instance, Radio Frequency (RF) resources of the wireless communication device may be tuned away to the second subscription for activities (e.g., pages) of the second subscription. Thus, the page of the first subscription may not be received or decoded when the paging occasion of the first subscription collides with the activities of the second subscription.

A first network associated with the first subscription may communicate (e.g., send or broadcast emergency-related pages) to the wireless communication device regardless of whether the first subscription is in the RRC-connected state or in the RRC-idle state. Repeated decoding failure can result in complete failure to decode the network's communications (especially emergency-related pages), thus negatively impacting user experience.

### SUMMARY

In various embodiments, a method for a wireless communication device having a first Subscriber Identity Module (SIM) associated with a first subscription and a second SIM associated with a second subscription to manage communications over the first subscription and the second subscription, the method includes determining valid paging occasions associated with the first subscription, determining a selected paging occasion of the valid paging occasions based on at least one of activities of the second subscription or a sleep period of the first subscription, and receiving a page of the first subscription on the selected paging occasion.

In some examples, the valid paging occasions associated with the first subscription are determined based on one or more of International Mobile Subscriber Identity (IMSI), length of a Discontinuous Reception (DRX) cycle, number of channels, or network parameters received from a first mobile network associated with the first subscription.

In some examples, determining the valid paging occasions associated with the first subscription includes calculating the valid paging occasions from a first mobile network associated with the first subscription, and storing the valid paging occasions.

In some examples, the valid paging occasions are determined in response to completing registration to a first mobile network associated with the first subscription.

In some examples, determining the selected paging occasion of the valid paging occasions based on at least one of the activities of the second subscription or the sleep period of the first subscription includes determining a first paging occasion of the valid paging occasions based on the activities of the second subscription.

In some examples, determining the first paging occasion includes determining the activities of the second subscription, and selecting the first paging occasion from the valid paging occasions, wherein the first paging occasion avoids the activities of the second subscription.

In some examples, the method further includes determining a designated paging occasion, wherein the designated paging occasion is one of the valid paging occasions, and determining that the designated paging occasion collides with the activities of the second subscription, wherein the first paging occasion is a paging occasion closest to the designated paging occasion that avoids the activities of the second subscription.

In some examples, the first paging occasion is a paging occasion closest to the designated paging occasion that avoids the activities of the second subscription in a same DRX cycle.

In some examples, determining the selected paging occasion of the valid paging occasions based on at least one of the activities of the second subscription or the sleep period of the first subscription further includes determining a second paging occasion of the valid paging occasions based on the sleep period of the first subscription.

In some examples, determining the second paging occasion includes selecting the second paging occasion from the valid paging occasions, wherein the second paging occasion avoids the sleep period of the first subscription and the activities of the second subscription.

In some examples, the second paging occasion is a paging occasion closest to the first paging occasion that avoids the sleep period of the first subscription.

In some examples, the second paging occasion is a paging occasion closest to the first paging occasion that avoids the sleep period of the first subscription in a same DRX cycle.

In some examples, the sleep period is a Connected Discontinuous Reception (CDRX) sleep period.

In some examples, the selected paging occasion is determined for every DRX cycle.

In some examples, the page of the first subscription includes an emergency-related page.

In some examples, the emergency-related page is related to one or more of Tsunami Warning Service (ETWS) or Commercial Mobile Alert System (CMAS).

In some examples, the first subscription is associated with active data transfer.

In some examples, the first subscription is a Long Term Evolution (LTE) subscription, and the second subscription is a LTE subscription, Wideband Code Division Multiple Access (WCDMA) subscription, Global System for Mobile Communications (GSM) subscription, or Code Division Multiple Access 1× Radio Transmission Technology (1×) subscription.

In some examples, the first subscription is in a Radio Resource Control (RRC)-connected state, and the second subscription is in a RRC-idle state.

In various examples, a wireless communication device includes at least one radio frequency (RF) resource, a processor configured to connect to a first SIM associated with a first subscription and to a second SIM associated with a second subscription, and configured with processor-executable instructions to determine valid paging occasions associated with the first subscription, determine a selected paging occasion of the valid paging occasions based on at least one of activities of the second subscription or a sleep period of the first subscription, and receive a page of the first subscription on the selected paging occasion, and a memory.

In some examples, the processor determines the selected paging occasion of the valid paging occasions based on at least one of the activities of the second subscription or the sleep period of the first subscription by determining a first paging occasion of the valid paging occasions based on the activities of the second subscription.

In some examples, the processor determines the first paging occasion by determining the activities of the second subscription, and selecting the first paging occasion from the valid paging occasions, wherein the first paging occasion avoids the activities of the second subscription.

In some examples, the processor is further configured to determine a designated paging occasion, wherein the designated paging occasion is one of the valid paging occasions, and determine that the designated paging occasion collides with the activities of the second subscription, wherein the first paging occasion is a paging occasion closest to the designated paging occasion that avoids the activities of the second subscription.

In some examples, the first paging occasion is a paging occasion closest to the designated paging occasion that avoids the activities of the second subscription in a same DRX cycle.

In some examples, the processor determines the selected paging occasion of the valid paging occasions based on at least one of the activities of the second subscription or the sleep period of the first subscription further by determining a second paging occasion of the valid paging occasions based on the sleep period of the first subscription.

In some examples, the processor determines the second paging occasion by selecting the second paging occasion from the valid paging occasions, wherein the second paging occasion avoids the sleep period of the first In some examples, the second paging occasion is a paging occasion closest to the first paging occasion that avoids the sleep period of the first subscription.

In some examples, the second paging occasion is a paging occasion closest to the first paging occasion that avoids the sleep period of the first subscription in a same DRX cycle.

According to various examples, a method for a wireless communication device having a first SIM associated with a first subscription and a second SIM associated with a second subscription to manage communications over the first subscription and the second subscription, the method includes determining valid paging occasions associated with the first subscription, determining activities of the second subscription, determining a sleep period of the first subscription, selecting a first set of at least one paging occasion from the valid paging occasions based on the activities of the second subscription, selecting a second set of at least one paging occasion from the first set based on the sleep period of the first subscription, and determining a selected paging occasion from the second set to receive a page of the first subscription.

According to various examples, a wireless communication device, includes at least one RF resource, a processor configured to connect to a first Subscriber Identity Module (SIM) associated with a first subscription and to a second SIM associated with a second subscription, and configured with processor-executable instructions to determine valid paging occasions associated with the first subscription, determine activities of the second subscription, determine a sleep period of the first subscription, select a first set of at least one paging occasion from the valid paging occasions based on the activities of the second subscription, select a second set of at least one paging occasion from the first set based on the sleep period of the first subscription, and determine a selected paging occasion from the second set to receive a page of the first subscription, and a memory.

In some examples, determining the selected paging occasion of the valid paging occasions based on the at least one of the activities of the second subscription or the sleep period of the first subscription includes determining that each of the valid paging occasions collides with the at least one of the activities of the second subscription or the sleep period of the first subscription, abandoning a CDRX mode with respect to the first subscription, and determining the selected paging occasion of the valid paging occasions based on the activities of the second subscription.

In some examples, each of the valid paging occasions is determined to be colliding with the at least one of the activities of the second subscription or the sleep period of the first subscription in a DRX cycle.

In some examples, abandoning the CDRX mode with respect to the first subscription includes waking up from the sleep period of the first subscription in a DRX cycle.

In some examples, determining the selected paging occasion of the valid paging occasions based on the at least one of the activities of the second subscription or the sleep period of the first subscription includes determining that each of the valid paging occasions collides with the at least one of the activities of the second subscription or the sleep period of the first subscription, denying tune-away to the second subscription that corresponds to the activities of the second subscription, and determining the selected paging occasion of the valid paging occasions based on the sleep period of the first subscription.

In some examples, the tune-away to the second subscription is denied by assigning the first subscription to have priority for usage of RF resource over the second subscription.

In some examples, the tune-away to the second subscription is denied by setting the first subscription to be in a RRC-idle state.

In some examples, the tune-away to the second subscription is denied in a DRX cycle.

In some examples, the method further includes determining that each of the valid paging occasions collides with the at least one of the activities of the second subscription or the sleep period of the first subscription in at least one subsequent DRX cycle, and alternating the first subscription and the second subscription for RF resource assignment.

### BRIEF DESCRIPTION OF THE DRAWINGS

The accompanying drawings, which are incorporated herein and constitute part of this specification, illustrate exemplary examples of the disclosure, and together with the general description given above and the detailed description given below, serve to explain the features of the various examples.

FIG. 1 is a schematic diagram of a communication system in accordance with various examples.

FIG. 2 is a component block diagram of a wireless communication device according to various examples.

FIG. 3 is a process flowchart diagram illustrating a scheduling method according to various examples.

FIG. 4 is a schematic diagram illustrating determining a selected paging occasion according to various examples.

FIG. 5 is a process flow diagram illustrating a scheduling method according to various examples.

FIG. 6 is a process flow diagram illustrating a scheduling method according to various examples.

FIG. 7 is a process flow diagram illustrating a scheduling method according to various examples.

FIG. 8 is a process flow diagram illustrating a scheduling method according to various examples.

FIG. 9 is a component block diagram of a wireless communication device suitable for use with various examples.

### DETAILED DESCRIPTION

Various examples will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the disclosure or the claims.

A modern communication device, referred to herein as a wireless communication device, User Equipment (UE), or Mobile Station (MS), may include one or more of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar personal electronic devices. Such a wireless communication device may include at least one Subscriber Identity Module (SIM), a programmable processor, memory, and circuitry for connecting to two or more mobile communication networks.

A wireless communication device may include one or more SIMs that enable access to one or multiple separate mobile communication networks. The access to mobile communication networks may be facilitated by Radio Access Technologies (RATs). The wireless communication device may be configured to connect to one or more base stations via one or more RATs. Examples of RATs may include, but not limited to, Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS), Wideband Code Division Multiple Access (WCDMA), Long Term Evolution (LTE), High-Speed Downlink Packet Access (HSDPA), and the like), Global System for Mobile Communications (GSM), Code Division Multiple Access 1× Radio Transmission Technology (1×), General Packet Radio Service (GPRS), Wi-Fi, Personal Communications Service (PCS), and other protocols that may be used in a wireless communications network or a data communications network. Each RAT may be associated with a subscription or SIM.

A wireless communication device provided with a plurality of SIMs and connected to two or more networks with one SIM being active at a given time is a Multi-SIM-Multi-Standby (MSMS) communication device. In one example, the MSMS communication device may be a Dual-SIM-Dual-Standby (DSDS) communication device, which may include two SIMs that may both be active on standby, but one may be deactivated when the other one is in use. In another example, the MSMS communication device may be a Triple-SIM-Triple-Standby (TSTS) communication device, which includes three SIMs that may all be active on standby, where two may be deactivated when a third one is in use. In other examples, the MSMS communication device may be other suitable multi-SIM communication devices, with, for example, four or more SIMs, such that when one is in use, the others may be deactivated.

On the other hand, a wireless communication device that includes a plurality of SIMs and connects to two or more networks with two or more SIMs being active at a given time may be a MSMA communication device. An example MSMA communication device may be a Dual-SIM-Dual-Active (DSDA) communication device, which may include two SIM. Both SIMs may remain active. In another example, the MSMA device may be a Triple-SIM-Triple-Active (TSTA) communication device, which may include three SIM. All three SIMs may remain active. In other examples, the MSMA communication device may be other suitable multi-SIM communication devices with four or more SIMs, all of which may be active.

Generally, examples described herein may be applicable to a MSMS wireless communication device having at least a first SIM and a second SIM. Illustrating with a non-limiting example, the first SIM may be associated with a first subscription, and the second SIM may be associated with a second subscription. Additionally or alternatively, the examples may be applicable to a MSMA wireless communication device having its first subscription influenced by activities (also referring to activity) of the second subscription due to interference, activity pattern, power back-off, and/or the like associated with the second subscription.

As used herein, the terms “SIM,” “SIM card,” and “subscriber identification module” may be used interchangeably to refer to a memory that may be an integrated circuit or embedded into a removable card, and that stores an International Mobile Subscriber Identity (IMSI), related key, and/or other information used to identify and/or authenticate a wireless communication device on a network and enable communication services with the network. A SIM as referred to herein may be a physical SIM, virtual SIM, soft SIM, or the like. Because the information stored in a SIM may be used to establish a communication link for a particular communication service with a particular network, the term “SIM” may also be used herein as a shorthand reference to the communication service (e.g., the networks, the subscriptions, the services, and/or the like) associated with and enabled by the information (e.g., in the form of various parameters) stored in a particular SIM as the SIM and the communication network, as well as the services and RATs supported by that network, correlate to one another.

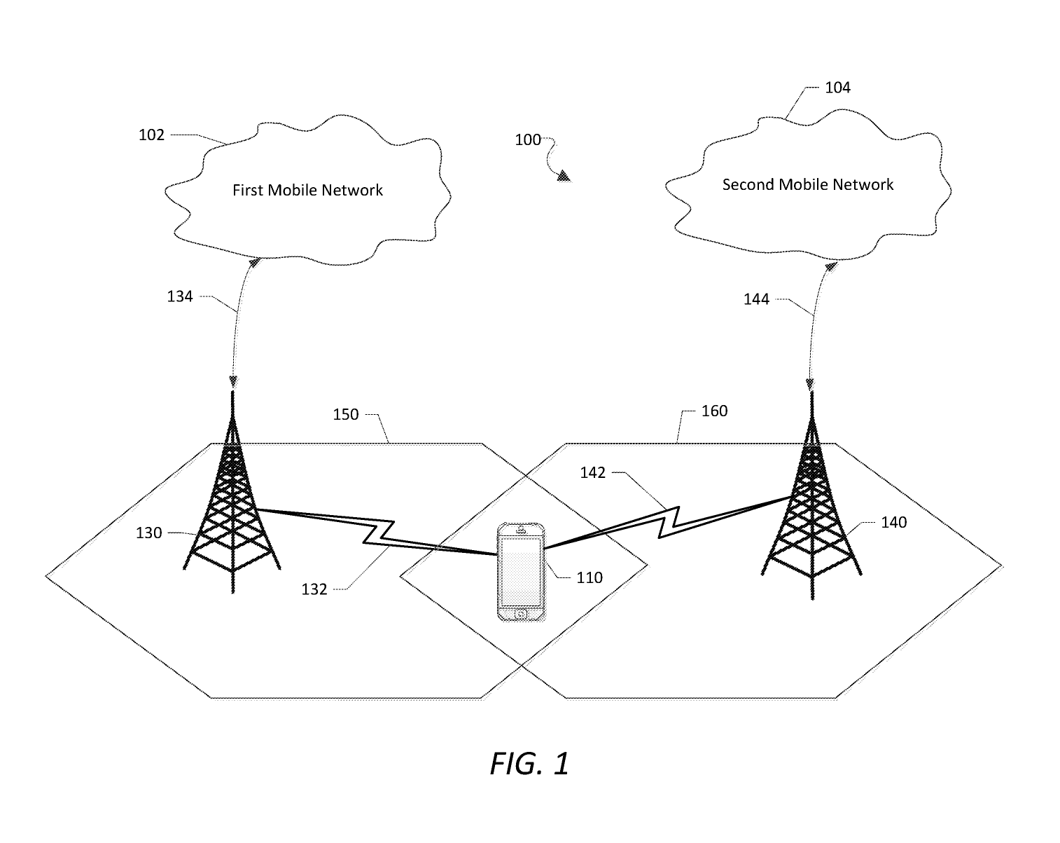

In some instances, the network (e.g., a first mobile network 102 of FIG. 1) may typically page a wireless communication device with emergency-related information indicating, for example, System Information Block (SIB) modification. New or modified SIBs may contain broadcast information or indications of new channels that need to be decoded in order to receive the broadcast information. The network relies on each wireless communication device connected to the network to successfully receive and decode the pages in order to distribute the information to each connected wireless communication device.

The network may broadcast the emergency-related pages to all wireless communication devices registered to the network. Specifically, to ensure successful broadcasting of the emergency-related information, the network may typically transmit the emergency-related pages in every valid paging occasion for all wireless communication devices registered to the network, regardless of whether or not a particular wireless communication device can or prefers to decode on a particular one of the valid paging occasions. In addition, the wireless communication devices may decode pages for the second (idle) subscription regardless of a current state of the wireless communication device.

A multi-SIM wireless communication device may have a first subscription in a Radio Resource Control (RRC)-connected state and a second subscription in a RRC-idle or Radio Resource (RR)-idle state. The first subscription may be performing active data transfer. Traditionally, when pages of the first subscription collide with the activities of the second subscription, the second subscription (e.g., the RRC-idle subscription) may have priority over the first subscription. This may result in the wireless communication device failing to decode pages for the first subscription. If a considerable number of pages of the second subscription collide with the activities of the first subscription, the wireless communication device can miss a substantial number or all of the pages of the first subscription.

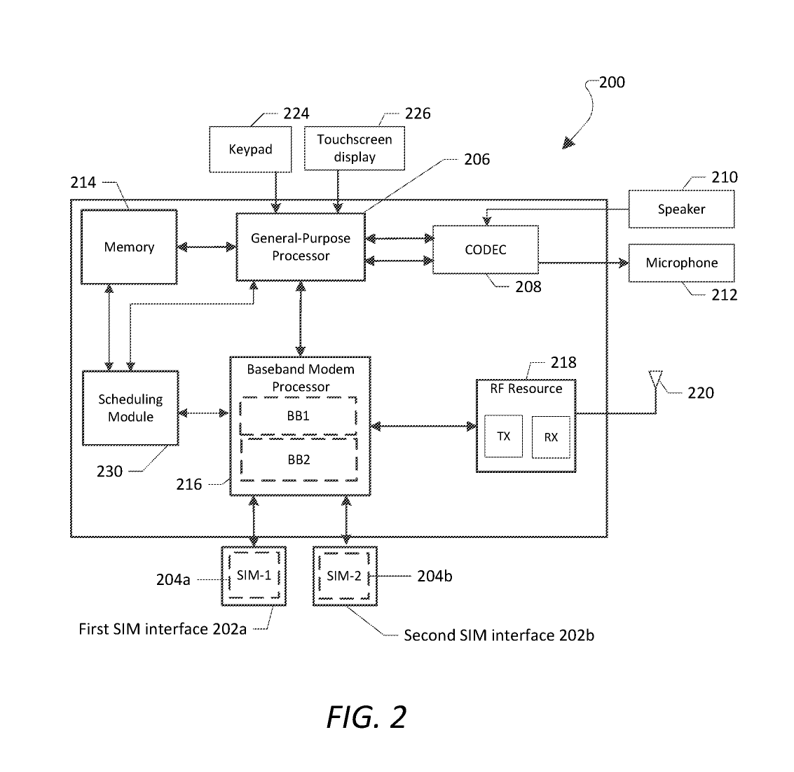

This effect can be especially pronounced when the pages of both subscriptions happen to align in time. Time alignment of pages of both subscription may occur when a Discontinuous Reception (DRX) period of both subscriptions are multiples of one another. Illustrating with a non-limiting example, time alignment of pages may occur when the DRX period of the first subscription (e.g., a LTE subscription) may be 1.28 s and the DRX period of the second subscription (e.g., a WCDMA subscription) may be 0.64 s. In some examples, the wireless communication device may determine paging occasions of the second subscription in advance, through a common entity/module (e.g., a scheduling module 230 (FIG. 2) implemented with a general-purpose processor 206 of (FIG. 2) of the wireless communication device 200 of (FIG. 2) that communicates with both subscriptions. In other words, the wireless communication device may determine in advance whether pages of the first subscription will collide with the activities of the second subscription.

To address such technical issues, the examples described herein exploit the fact that the network (e.g., a first mobile network 102 of FIG. 1) of the first subscription broadcasts pages on all valid paging occasions to ensure that all wireless communication devices can decode the pages. The valid paging occasions for the first subscription may be determined for a particular wireless communication device based on one or more of the IMSI or another identifier of the first SIM (first subscription), DRX cycle length, number of channels, and/or at least one network-specific parameter. All valid paging occasions (e.g., the timings thereof) of the first subscription can be accordingly calculated and saved within the wireless communication device after registration on particular cell (e.g., a first cell 150 of FIG. 1). Illustrating with a non-limiting example with respect to LTE, the valid paging occasions may include Subframes 0, 4, 5, and 9 for Frequency-Division Duplexing (FDD) and Subframes 0, 1, 5, and 6 for Time-Division Duplexing (TDD) (based on Specification ETSI TS 136 304 V10.5.0 (2012-03), 7.2 Subframe Patterns).

Although a wireless communication device connected to the network may be assigned a designated paging occasion to decode the pages, the wireless communication device may be configured to decode the pages on paging occasions other than the designated paging occasion. With knowledge of the timings of all valid paging occasions and the activities of the second subscription, the wireless communication device may determine at least one (e.g., a first paging occasion) of the valid paging occasions for receiving the pages. The first paging occasion may be selected to avoid (not overlap with) activities of the second subscription. The first paging occasion may be a nearest possible paging occasion to the designated paging occasion. Given the page information may be transmitted on a common channel and may be modulated or scrambled with common Identification (ID) or sequence, the wireless communication device may be configured to decode pages on a paging occasion (e.g., the first paging occasion) that is not the designated paging occasion.

In every DRX cycle, the wireless communication device may be configured to decode at least one or only one page to ensure that there is no significant delay in receiving emergency-related pages. Within each DRX period, at least one or only one paging occasion (e.g., the first paging occasion) may be scheduled for decoding the emergency-related page of the first subscription.

In addition, the first subscription may sleep (in a Connected DRX (CDRX) sleep period) while in the RRC-connected state. In this case, the first subscription may account for the CDRX sleep period by determining a second one (e.g., a second paging occasion) of the valid paging occasions that does not overlap with the CDRX sleep period. In some examples in which the wireless communication device accounts for both the activities of the second subscription and the CDRX sleep period, the first paging occasion (which is determined based on activities of the second subscription) may fall within the CDRX sleep period and may be disregarded. In this case, the second paging occasion that avoids both the activities of the second subscription and the CDRX sleep period may be selected. The second paging occasion may be a closest paging occasion to the designated paging occasion.

In some instances in which none of the valid paging occasions can avoid one or both of the activities of the second subscription or the CDRX sleep period within a same DRX period, the wireless communication device may deny tuning away to the second subscription in that DRX period. In addition or alternatively, the wireless communication device may assign each subscription the RF resource for a certain time interval (e.g., at least one DRX period or a portion of a DRX period) so that the second subscription does not consistently collide with or otherwise block the first subscription.

Various examples may be implemented within a communication system 100, an example of which is illustrated in FIG. 1. Referring to FIG. 1, a first mobile network 102 and a second mobile network 104 may each associate with a plurality of cellular base stations (e.g., a first base station 130 and a second base station 140, respectively). The first base station 130 may enable the first mobile network 102 in a first serving cell 150. The second base station 140 may enable the second mobile network 104 in a second serving cell 160. A wireless communication device 110 may be associated with (within effective boundaries of) both the first serving cell 150 and the second serving cell 160.

The wireless communication device 110 may be in communication with the first mobile network 102 through a first cellular connection 132 to the first base station 130. The first cellular connection 132 may correspond to the first RAT of the wireless communication device 110. The wireless communication device 110 may be in communication with the second mobile network 104 through a second cellular connection 142 to the second base station 140. The second cellular connection 142 may correspond to the second RAT of the wireless communication device 110, as in a multi-SIM context. The first base station 130 may be in communication with the first mobile network 102 over a wired or wireless connection 134. The second base station 140 may be in communication with the second mobile network 104 over a wired or wireless connection 144.

Each of the first cellular connection 132 and the second cellular connection 142 may be a two-way wireless communication link. Each wireless communication link may be enabled by any suitable protocol (RAT) including, but not limited to, FDMA, TDMA, CDMA (e.g., EVDO), UMTS (e.g., WCDMA, LTE, HSDPA, or the like), GSM, 1×, GPRS, Wi-Fi, PCS, and/or another protocol used in a wireless communications network or a data communications network. By way of illustrating with a non-limiting example, the first cellular connection 132 may be a LTE connection. The second cellular connection 142 may be a LTE, WCDMA, GSM or 1× connection. Other RATs (such as, but not limited to, HSDPA, EVDO, and the like) may be implemented in a similar manner.

Each of the first base station 130 and the second base station 140 may include at least one antenna group or transmission station located in the same or different areas. The at least one antenna group or transmission station may be associated with signal transmission and reception. Each of the first base station 130 and the second base station 140 may include one or more processors, modulators, multiplexers, demodulators, demultiplexers, antennas, and the like for performing the functions described herein. In some examples, each of the first base station 130 and the second base station 140 may be an access point, Node B, evolved Node B (eNodeB or eNB), base transceiver station (BTS), or the like.

In various examples, the wireless communication device 110 may be configured to access the first mobile network 102 and the second mobile network 104 by virtue of the multi-SIM and/or the multi-mode SIM configuration of the wireless communication device 110 (e.g., via the first cellular connection 132 and the second cellular connection 142). When a SIM corresponding to a RAT is inserted or otherwise provided, the wireless communication device 110 may access the mobile communication network associated with that RAT based on the information stored on the SIM through registrations and call setups, as described herein.

While the wireless communication device 110 is shown connected to the mobile networks 102 and 104 via two cellular connections, in other examples (not shown), the wireless communication device 110 may establish additional network connections using at least one additional RAT.

In some examples, the wireless communication device 110 may establish a wireless connection with a peripheral device (not shown) used in connection with the wireless communication device 110. For example, the wireless communication device 110 may communicate over a Bluetooth® link with a Bluetooth-enabled personal computing device (e.g., a “smart watch”). In some examples, the wireless communication device 110 may establish a wireless connection with a wireless access point (not shown), such as over a Wi-Fi connection. The wireless access point may be configured to connect to the Internet or another network over a wired connection.

FIG. 2 is a functional block diagram of a wireless communication device 200 suitable for implementing various examples. According to various examples, the wireless communication device 200 may be the wireless communication device 110 as described with reference to FIG. 1. Referring to FIGS. 1-2, the wireless communication device 200 may include a first SIM interface 202a, which may receive a first identity module SIM-1 204a that is associated with the first subscription (corresponding to the first mobile network 102). The wireless communication device 200 may include a second SIM interface 202b, which may receive a second identity module SIM-2 204b that is associated with the second subscription (corresponding to the second mobile network 104).

A SIM (e.g., SIM-1 204a, SIM-2 204b, and/or the like) in various examples may be a Universal Integrated Circuit Card (UICC) that is configured with SIM and/or Universal SIM (USIM) applications, enabling access to GSM and/or UMTS networks. The UICC may also provide storage for a phone book and other applications. Alternatively, in a CDMA network, a SIM may be a UICC removable user identity module (R-UIM) or a CDMA Subscriber Identity Module (CSIM) on a card. A SIM card may have one or more of a Central Processing Unit (CPU), Read Only Memory (ROM), Random Access Memory (RAM), Electrically Erasable Programmable Read-Only Memory (EEPROM) and Input/Output (I/O) circuits. An Integrated Circuit Card Identity (ICCID) SIM serial number may be printed on the SIM card for identification. In an example in which the SIM is a virtual SIM or soft SIM, a SIM may be implemented within a portion of memory of the wireless communication device 200, and thus need not be a separate or removable circuit, chip, or card.

A SIM used in various examples may store user account information, an IMSI, a set of SIM Application Toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

The wireless communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The general-purpose processor 206 may include any suitable data processing device, such as a microprocessor. In the alternative, the general-purpose processor 206 may be any suitable electronic processor, controller, microcontroller, or state machine. The general-purpose processor 206 may also be implemented as a combination of computing devices (e.g., a combination of a Digital Signal Processor (DSP) and a microprocessor, a plurality of microprocessors, at least one microprocessor in conjunction with a DSP core, or any other such configuration).

The memory 214 may include a non-transitory processor-readable storage medium that stores processor-executable instructions. For example, the instructions may include routing communication data relating to the first or second subscription though a corresponding baseband-RF resource chain. The memory 214 may include any suitable internal or external device for storing software and data. Examples of the memory 214 may include, but not limited to, RAM, ROM, floppy disks, hard disks, dongles or other Recomp Sensor Board (RSB) connected memory devices, or the like. The memory 214 may store an Operating System (OS), user application software, and/or executable instructions. The memory 214 may also store application data, such as an array data structure.

The general-purpose processor 206 and the memory 214 may each be coupled to baseband modem processor 216. The SIMs (e.g., the SIM-1 204a, the SIM-2 204b, and/or the like) in the wireless communication device 200 may be associated with at least one baseband-RF resource chain. A baseband-RF resource chain may include the baseband modem processor 216, which may perform baseband/modem functions for communications on the SIMs. The baseband modem processor 216 may include one or more amplifiers and radios, referred to generally herein as a RF resource 218 or RF chain.

The examples described herein may be applicable to wireless communication devices in which the SIMs 204a and 204b share a common set of RF resource (particularly, the RF resource 218). Examples described herein may be applicable to wireless communication devices in which each of the SIMs 204a and 204b is associated with a separate RF resource, but activities of one of the SIMs 204a and 204b may be deactivated while the other one of the SIMs 204a and 204b is active.

The RF resource 218 may include at least one transceiver that perform transmit/receive functions for the associated SIMs 204a and 204b. The RF resource 218 may include separate transmit and receive circuitry, or may include a transceiver that combines transmitter and receiver functions. The RF resource 218 may be coupled to a wireless antenna 220. The RF resource 218 may be coupled to the baseband modem processor 216.

In some examples, the general-purpose processor 206, the memory 214, the baseband modem processor 216, and the RF resource 218 may be included in the wireless communication device 200 as a system-on-chip. In some examples, the SIMs 204a and 204b and their corresponding interfaces 202a, 202b may be external to the system-on-chip. Further, various input and output devices may be coupled to components on the system-on-chip, such as interfaces or controllers. Example user input components suitable for use in the wireless communication device 200 may include, but are not limited to, a keypad 224, a touchscreen display 226, and the microphone 212.

In some examples, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the wireless communication device 200 to enable communications therebetween.

The wireless communication device 200 may include a scheduling module 230 capable of performing the functions described herein with respect to scheduling activities of the first subscription and the second subscription. The scheduling module 230 may communicate with the software layers corresponding to both the first subscription and the second subscription. Particularly, the scheduling module 230 may communicate with the software layer corresponding to the second subscription to obtain activities of the second subscription that have been scheduled in advance. The scheduling module 230 may use the information regarding the future activities of the second subscription to schedule reception and decoding of first subscription pages on a selected paging occasion in the manner described.

In some examples, the scheduling module 230 may be implemented within the general-purpose processor 206. For example, the scheduling module 230 may be implemented as a software application stored within the memory 214 and executed by the general-purpose processor 206. Accordingly, such examples can be implemented with minimal additional hardware costs. However, other examples relate to systems and processes implemented with dedicated hardware specifically configured for performing operations described herein with respect to the scheduling module 230. For example, the scheduling module 230 may be implemented as a separate processing component (i.e., separate from the general-purpose processor 206). The scheduling module 230 may be coupled to the memory 214, the general processor 206, the baseband processor 216, and/or the RF resource 218 for performing the function described herein.

Hardware and/or software for the functions may be incorporated in the wireless communication device 200 during manufacturing, for example, as a part of a configuration of an original equipment manufacturer (OEM) of the wireless communication device 200. In further examples, such hardware and/or software may be added to the wireless communication device 200 post-manufacture, such as by installing one or more hardware devices and/or software applications onto the wireless communication device 200.

In some examples, the wireless communication device 200 may include, among other things, to additional SIMs, SIM interfaces, at least another RF resource associated with the additional SIMs, and additional antennas for connecting to additional mobile networks.

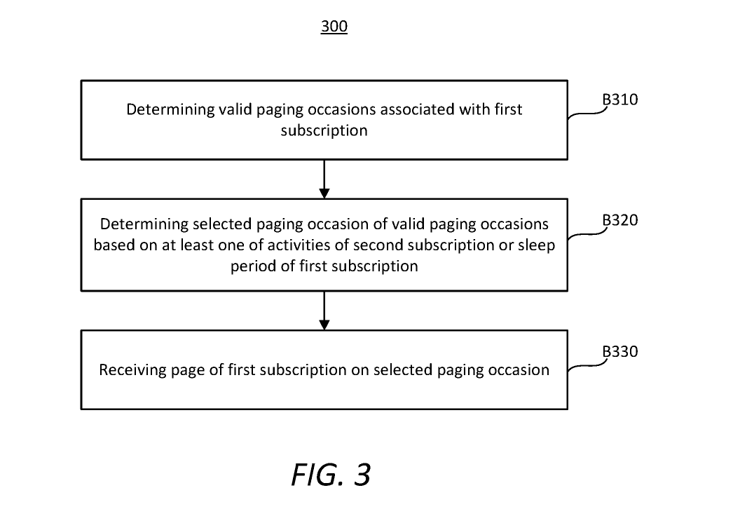

FIG. 3 is a process flowchart diagram illustrating a scheduling method 300 according to various examples. Referring to FIGS. 1-3, in some examples, the scheduling module 230 or the general-purpose processor 206 may determine valid paging occasions associated with the first subscription at block B310. The first subscription may be enabled by the first SIM (SIM-1 204a) associated with the first mobile network 102. The wireless communication device 200 may have the second subscription enabled by the second SIM (SIM-2 204b) associated with the second mobile network 104.

In some examples, the first subscription may be in a RRC-connected state. The second subscription may be in a RRC-idle state. The first subscription may be on active data transfer (that is, the scheduling module 230 or the general-purpose processor 206 may configure one or more of the baseband modem processor 216, RF resource 218, antenna 220, or the like to communicate with the first mobile network 102 for active data transfer activities.

Illustrating with a non-limiting example, the first subscription may be a LTE subscription. The second subscription may be a LTE subscription, WCDMA subscription, GSM subscription, 1× subscription, or the like. In some examples, each of the first subscription and the second subscription may communicate via any suitable RATs (e.g., any RAT defined in the 3^{rd} Generation Partnership Project (3GPP), 3^{rd} Generation Partnership Project 2 (3GPP2), or other known standards).

A paging occasion may be a subframe in which paging-related info may be transmitted on a downlink channel (e.g., a Physical Downlink Channel (PDSCH) on LTE) to transmit a paging message. The valid paging occasions may include all possible paging occasions on which the wireless communication device 200 may receive and decode pages. For instance, the valid paging occasions for LTE FDD may include Subframes 0, 4, 5, and 9. The valid paging occasions for LTE TDD may include Subframes 0, 1, 5, and 6.

In some examples, the scheduling module 230 or the general-purpose processor 206 may determine the valid paging occasions based on one or more of the IMSI, length of the DRX cycle, number of channels, or one or more network parameter received from the first mobile network 102. In other examples, the first mobile network 102 (e.g., through the first base station 130 or a suitable processor) may determine the valid paging occasions for one or more wireless communication devices connected to the first mobile network 102, including the wireless communication device 200. The valid paging occasions (determined by the first mobile network 102) may be received by the wireless communication device 200 via one or more of the baseband modem processor 216, RF resource 218, or antenna 220. The wireless communication device 200 may save the valid paging occasions in the memory 214 for subsequent look-up. The determination of the valid paging occasions may occur after the wireless communication device 200 successfully camps on the first cell 150.

At block B320, the scheduling module 230 or the general-purpose processor 206 may determine a selected paging occasion of the valid paging occasions, based on at least one of the activities of the second subscription or a sleep period of the first subscription in some examples. The selected paging occasion may be one of the valid paging occasions. In some examples, one and only one selected paging occasion may be determined for each DRX cycle (of the first subscription) to avoid significant delay in decoding emergency-related pages. In other examples, two or more selected paging occasion may be determined for each DRX cycle.

A designated paging occasion may be one of the valid paging occasions determined by the scheduling module 230 or the general-purpose processor 206 of the wireless communication device 200 in some examples. In other examples, the designated paging occasion may be assigned by the first mobile network 102. The designated paging occasion may be assigned for the wireless communication device 200 for decoding an emergency broadcast. Other paging occasions of the valid paging occasions may be assigned to other devices registered to the first mobile network 102 to decode the emergency broadcast. The designated paging occasion may collide or overlap with one or more of the activities of the second subscription or the sleep period of the first subscription, rending the designated paging occasion ineffective.

In some examples, the scheduling module 230 or the general-purpose processor 206 may determine a first paging occasion of the valid paging occasions, based on the activities of the second subscription. As described, the activities of the second subscription may be known in advance. The first paging occasion may be selected to avoid the activities of the second subscription. In other words, the first paging occasion may not overlap with the activities of the second subscription.

In some examples, the first paging occasion may be one of the valid paging occasions that may not overlap with the activities of the second subscription and is closest (in time) to the designated paging occasion, for example, in a paging occasion sequence or subframe sequence. The first paging occasion may be before or after the designated paging occasion in the same or adjacent DRX cycle. In some examples, the first paging occasion may be set as the selected paging occasion.

In other examples, the selected paging occasion may be a second paging occasion. In some examples, the scheduling module 230 or the general-purpose processor 206 may determine the second paging occasion of the valid paging occasions based on the sleep period (e.g., the CDRX sleep period) of the first subscription. The second paging occasion may be selected to avoid the sleep period of the first subscription. In other words, the second paging occasion may not overlap with the sleep period of the first subscription.

In some examples, the second paging occasion may be one of the valid paging occasions that do not overlap with the activities of the second subscription or the sleep period of the first subscription. In some examples, in response to the scheduling module 230 or the general-purpose processor 206 determining that the first paging occasion overlaps with the sleep period of the first subscription, the first paging occasion may be disregarded. The scheduling module 230 or the general-purpose processor 206 may select another one (e.g., the second paging occasion) of the valid paging occasions that does not overlap with the activities of the second subscription or the sleep period of the first subscription. The second paging occasion may be the closest one of the valid paging occasions to the designated paging occasion in the same DRX cycle that does not overlap with the activities of the second subscription or the sleep period of the first subscription. The second paging occasion may be set as the selecting paging occasion. On the other hand, in response to determining that the first paging occasion does not overlap with the sleep period of the first subscription, then the scheduling module 230 or the general-purpose processor 206 may set the first paging occasion as the selected paging occasion because determination of the second paging occasion may not be needed.

At block B330, the scheduling module 230 or the general-purpose processor 206 may configure one or more of the baseband modem processor 216, RF resource 218, antenna 220, or the like to receive a page of the first subscription on the selected paging occasion in some examples. The page may be an emergency-related page such as, but not limited to, a page for Tsunami Warning Service (ETWS), Commercial Mobile Alert System (CMAS), and/or the like.

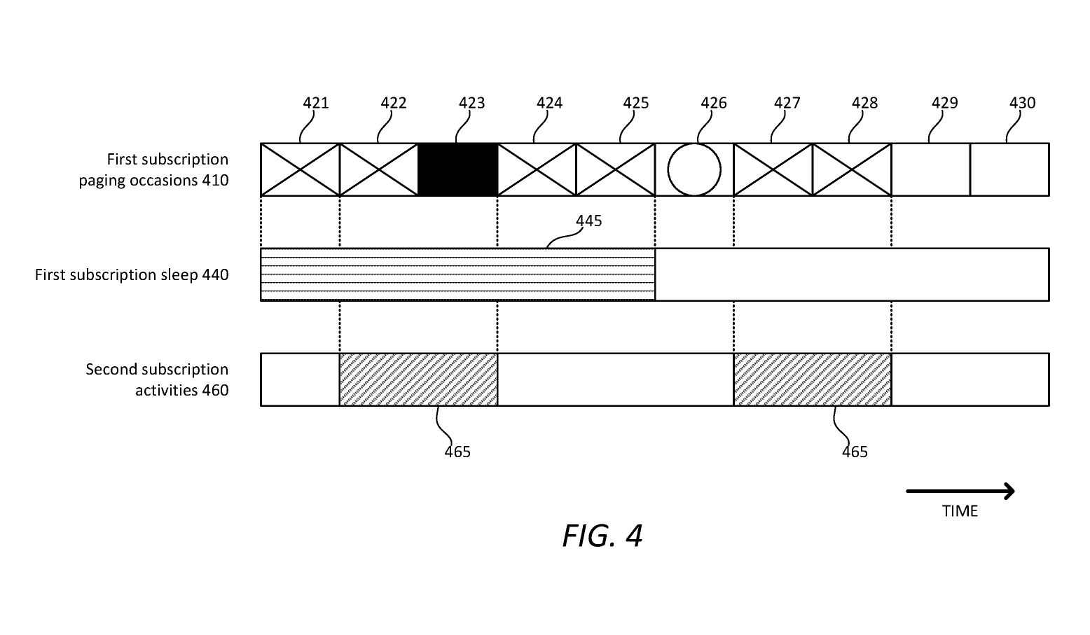

FIG. 4 is a schematic diagram illustrating determining a selected paging occasion according to various examples. Referring to FIGS. 1-4, first subscription paging occasions 410 may include valid paging occasions in a given DRX cycle. For example, the first subscription paging occasions 410 may include paging occasions 421-430. The RF resource 218 may be tuned away from the first subscription or become inactive due to a first subscription sleep 440 (e.g., during a first subscription sleep period 445) and/or second subscription activities 460 (e.g., during the second subscription activities intervals 465). The first subscription sleep 440 (and the first subscription sleep period 445) may be in the CDRX sleep period of the first subscription. The second subscription activities 460 (and the second subscription activities intervals 465) may include pages or other types of communications over the second subscription.

In some examples, the first paging occasion may be determined by the scheduling module 230 or the general-purpose processor 206, based on the second subscription activities intervals 465. Candidates for the first paging occasion may include paging occasions 421, 424, 425, 426, 429, and 430, because none of the paging occasions 421, 424, 425, 426, 429, and 430 collide or overlap with the second subscription activities intervals 465. In some examples, the first paging occasion may be selected to be a paging occasion closest to a designated paging occasion 423 that avoids the second subscription activities intervals 465. Thus, the first paging occasion in this non-limiting example may be the paging occasion 424 because the paging occasion 424 is directly adjacent to (one subframe from) the designated paging occasion 423.

The first paging occasion may have a subframe index number greater than or less than that of the designated paging occasion 423 as long as each paging occasion between the first paging occasion and the designated paging occasion 423 at least partially collide with the second subscription activities intervals 465. Assuming that the second subscription activities intervals 465 collide with the paging occasion 424, the first paging occasion may be either the paging occasion 421 or the paging occasion 425 because each paging occasion 421 or 425 is equally close (closest) to the designated paging occasion 423. In such a scenario, the earlier paging occasion 421 may be determined to be the first paging occasion in some examples. In other examples, the later paging occasion 425 may be determined to be the first paging occasion.

In some examples, the second paging occasion may be determined by the scheduling module 230 or the general-purpose processor 206, based on the first subscription sleep period 445. The first paging occasion 424 may overlap with the first subscription sleep period 445 and therefore may be disregarded. Candidates for the second paging occasion may include paging occasions 426, 429, and 430 because none of the paging occasions 426, 429, and 430 overlaps with the first subscription sleep period 445 (and none overlaps with the second subscription activities intervals 465). The second paging occasion (e.g., the paging occasion 426) may be set as the selected paging occasion in some examples.

In some examples, the second paging occasion may be selected to be a paging occasion closest to the designated paging occasion 423 that avoids the first subscription sleep period 445 and the second subscription activities intervals 465. Thus, the second paging occasion in this non-limiting example may be the paging occasion 426, because the paging occasion 426 is closer to the designated paging occasion 423 than each of the remaining paging occasions 429 and 430 in the same DRX cycle. In a scenario in which two paging occasions may be equidistant from the designated paging occasion 423, the scheduling module 230 or the general-purpose processor 206 may select the one prior in time (or with the lower subframe index number) to be the second paging occasion. In other examples, the paging occasion later in time (or with the higher index number) may be selected to be the second paging occasion. The second paging occasions may be set as the selected paging occasion.

One of ordinary skill in the art would appreciate that the non-limiting example in FIG. 4 is set forth for clarity, and the examples described with respect to FIG. 4 may likewise be implemented in scenarios involving other variations of number, sequence, and/or pattern of the paging occasions 421-430, second subscription activities intervals 465, first subscription sleep period 445, and/or the like.

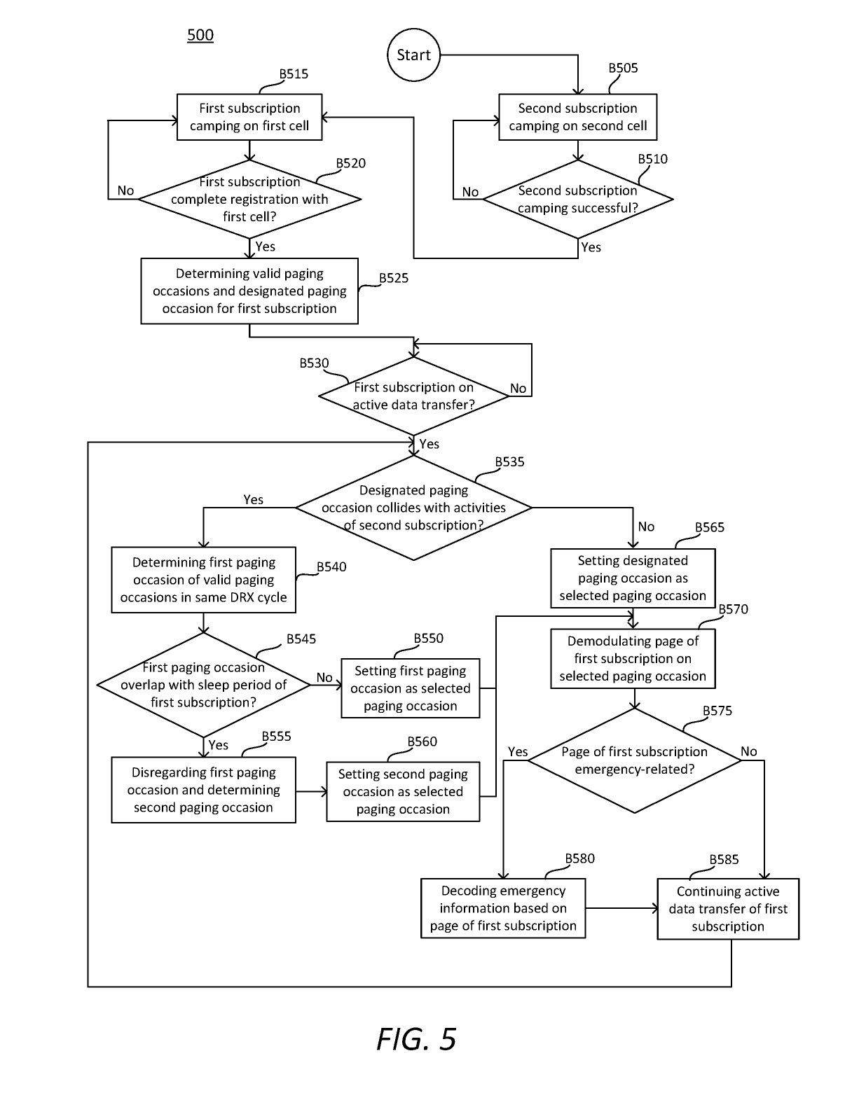

FIG. 5 is a process flow diagram illustrating a scheduling method 500 according to various examples. Referring to FIGS. 1-5, one or more of blocks B505-B585 may correspond to one of the blocks B310-B330 in some examples. At block B505, the scheduling module 230 or the general-purpose processor 206 may configure one or more of the baseband modem processor 216, RF resource 218, antenna 220, or the like to camp on the second cell 160 (e.g., with the second base station 140) according to some examples. At block B510, the scheduling module 230 or the general-purpose processor 206 may determine whether camping for the second subscription (e.g., at block B505) is successful. In response to determining that the camping has not been successful (B510:NO), the scheduling module 230 or the general-purpose processor 206 may continue to attempt to camp on the second cell 160 at block B505.

On the other hand, in response to determining that the camping has been successful (B510:YES), the scheduling module 230 or the general-purpose processor 206 may configure one or more of the baseband modem processor 216, RF resource 218, antenna 220, or the like to camp on the first cell 150 (e.g., with the first base station 130) at block B515. At block B520, the scheduling module 230 or the general-purpose processor 206 may determine whether registration with the first cell 150 has been completed. In response to determining that the registration has not been completed (B520:NO), the scheduling module 230 or the general-purpose processor 206 may continue to attempt to camp on the first cell 150 at block B515.

On the other hand, in response to determining that the registration has been completed (B520:YES), the scheduling module 230 or the general-purpose processor 206 may determine valid paging occasions (e.g., the paging occasions 421-430) and a designated paging occasion (e.g., the designated paging occasion 423) for the first subscription at block B525. In some examples, the scheduling module 230 or the general-purpose processor 206 may determine the valid paging occasions and/or the designated paging occasion based on one or more of the IMSI or another identifier of the first SIM, DRX cycle length, number of channels, and/or at least one network-specific parameter. In some examples, the wireless communication device 200 may receive and/or save (via one or more of the baseband modem processor 216, RF resource 218, antenna 220, or the like) the valid paging occasions and/or the designated paging occasion from the first mobile network 102. In some examples, the scheduling module 230 or the general-purpose processor 206 may internally look up the valid paging occasions and/or the designated paging occasion stored in the memory 214. In some examples, the blocks B505-B525 may be executed sequentially in any suitable order. In other examples, the blocks B505-B525 may be executed simultaneously.

At block B530, the scheduling module 230 or the general-purpose processor 206 may determine whether the first subscription is on active data transfer in some examples. In response to determining that the first subscription is not on active data transfer (B530:NO), the scheduling module 230 or the general-purpose processor 206 may continue to monitor or determine whether the first subscription is on active data transfer at block B530.

On the other hand, in response to determining that the first subscription is on active data transfer (B530:YES), the scheduling module 230 or the general-purpose processor 206 may determine whether the designated paging occasion collides with activities (e.g., the second subscription activities intervals 465) of the second subscription at block B535. For instance, the designated paging occasion 423 may collide with the second subscription activities intervals 465.

In response to determining that the designated paging occasion does not collide with activities of the second subscription (B535:NO), the scheduling module 230 or the general-purpose processor 206 may set the designated paging occasion to be the selected paging occasion at block B565. On the other hand, in response to determining that the designated paging occasion collides with activities of the second subscription (B535:YES), the scheduling module 230 or the general-purpose processor 206 may determine a first paging occasion of the valid paging occasions in the same or adjacent DRX cycle, at block B540. The first paging occasion may be one of the valid paging occasions that avoids or does not overlap with the activities of the second subscription. At block B545, the scheduling module 230 or the general-purpose processor 206 may determine whether the first paging occasion overlaps with a sleep period (e.g., the first subscription sleep period 445) of the first subscription.

In response to determining that the first paging occasion does not overlap with the sleep period of the first subscription (B545:NO), the scheduling module 230 or the general-purpose processor 206 may set the first paging occasion as the selected paging occasion at block B550. On the other hand, in response to determining that the first paging occasion overlaps with the sleep period of the first subscription (B545:YES), the scheduling module 230 or the general-purpose processor 206 may disregard the first paging occasion and determine a second paging occasion at block B555. For example, the second paging occasion may be another one of the valid paging occasions that does not overlap with the sleep period of the first subscription (and does not collide with the activities of the second subscription). The scheduling module 230 or the general-purpose processor 206 may set the second paging occasion as the selected paging occasion at block B560.

Following one of blocks B550, B560, or B565, the scheduling module 230 or the general-purpose processor 206 may receive and demodulate a page of the first subscription on the selected paging occasion at block B570. At block B575, the scheduling module 230 or the general-purpose processor 206 may determine whether the page of the first subscription is emergency-related (e.g., ETWS, CMAS, or the like). In response to determining that the page of the first subscription is emergency-related (B575:YES), the scheduling module 230 or the general-purpose processor 206 may decode the emergency information based on the page of the first subscription at block B580.

On the other hand, in response to determining that the page of the first subscription is not emergency-related (B575:NO) or in response to completing decoding the emergency information at block B580, the scheduling module 230 or the general-purpose processor 206 may continue the active data transfer on the first subscription at block B585. Following block B585, the method 500 then may continue at block B535 (e.g., for every DRX cycle). One selected paging occasion may be used to listen to the page of the first subscription in every DRX cycle.

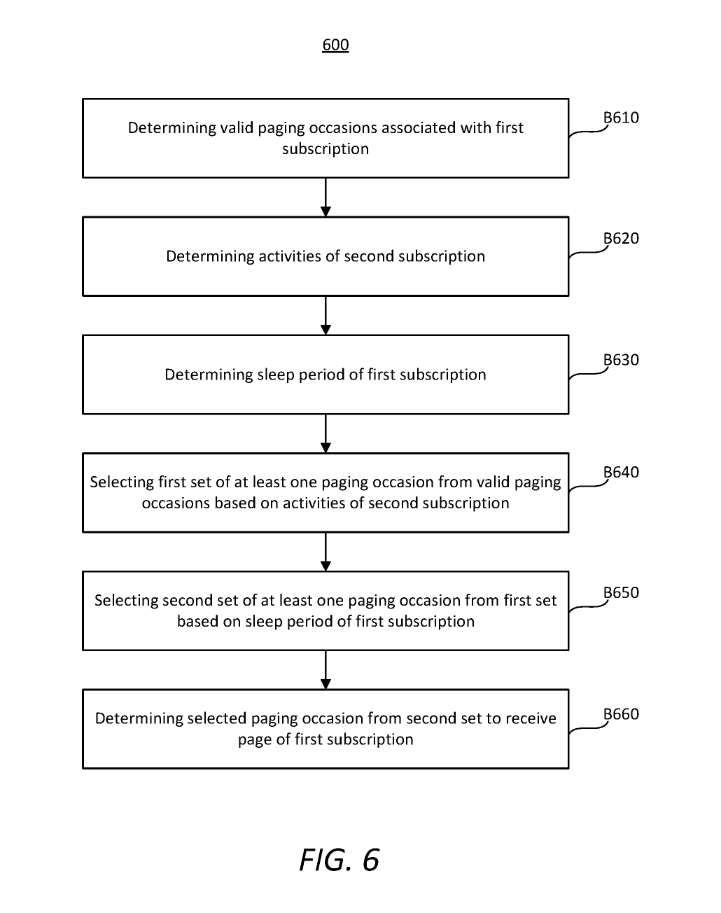

FIG. 6 is a process flow diagram illustrating a scheduling method 600 according to various examples. Referring to FIGS. 1-6, one or more of blocks B610-B660 may correspond to one of the blocks B310-B330 in some examples. At block B610, the scheduling module 230 or the general-purpose processor 206 may determine the valid paging occasions (e.g., the valid paging occasions 421-430) associated with the first subscription in the manner described. At block B620, the scheduling module 230 or the general-purpose processor 206 may determine the activities (e.g., the second subscription activities intervals 465) of the second subscription. At block B630, the scheduling module 230 or the general-purpose processor 206 may determine the sleep period (e.g., the first subscription sleep period 445) of the first subscription.

At block B640, the scheduling module 230 or the general-purpose processor 206 may select a first set of at least one paging occasion from the valid paging occasions based on the activities of the second subscription. Illustrating with a non-limiting example, the first set may include the paging occasions 421, 424, 425, 426, 429, and 430 given that the paging occasions 421, 424, 425, 426, 429, and 430 may not collide with the second subscription activities intervals 465.

At block B640, the scheduling module 230 or the general-purpose processor 206 may select a second set of at least one paging occasion from the first set based on the sleep period of the first subscription. Illustrating with a non-limiting example, the second set may include the paging occasions 426, 429, and 430 given that the paging occasions 426, 429, and 430 may not overlap the first subscription sleep period 445.

At block B650, the scheduling module 230 or the general-purpose processor 206 may determine the selected paging occasion from the second set to receive a page of the first subscription. The selected paging occasion may be one of the paging occasions in the second set that is closest (in time) to the designated paging occasion. Illustrating with a non-limiting example, the paging occasion 426 may be the closest to the designated paging occasion 423 and thus may be the selected paging occasion.

In some scenarios, the activities of the second subscription and the sleep period of the first subscription may collide with all valid paging occasions in a given DRX cycle, rendering the wireless communication device 200 unable to decode any emergency-related pages on the first subscription in that DRX cycle. Such collisions can persist through subsequent DRX cycles if the collisions are cyclic in nature, thus resulting in failure to decode any emergency-related pages on the first subscription for a considerable period of time. To address such issues, the scheduling module 230 or the general-purpose processor 206 may be capable of (1) configuring the first subscription to wake up from sleep (e.g., abandoning the CDRX mode with respect to the first subscription); and/or (2) denying tune-aways to the second subscription that correspond to at least some of the activities of the second subscription.

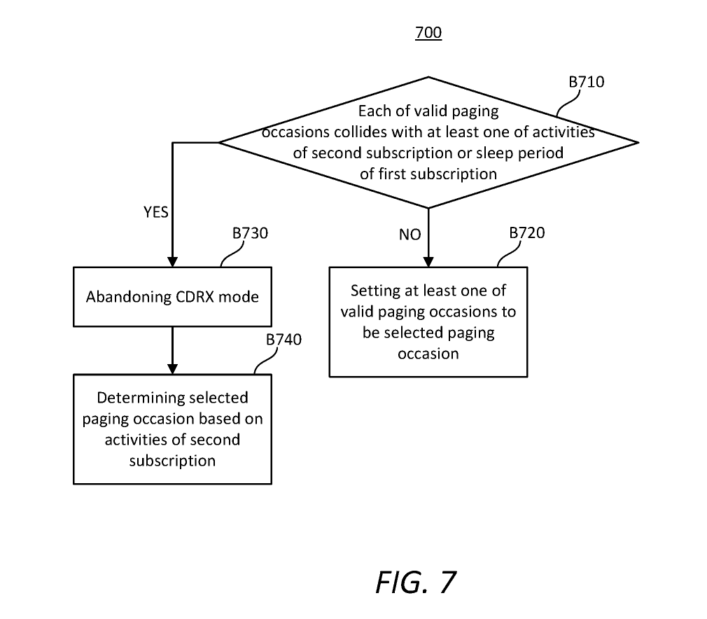

FIG. 7 is a process flow diagram illustrating a scheduling method 700 according to various examples. Referring to FIGS. 1-9, the scheduling method 700 shows an example of a particular aspect of the scheduling method 300. Specifically, block B320 may include blocks B710-B740 in some configurations. The scheduling method 700 is concerned with configuring the first subscription to wake up from sleep in response to determining that every valid paging occasion in a DRX cycle collides with the activities of the second subscription or the sleep period of the first subscription.

At block B710, the scheduling module 230 or the general-purpose processor 206 may determine whether each of the valid paging occasions collides with at least one of the activities of the second subscription or the sleep period of the first subscription. In some examples, the determination at block B710 may be made with respect to every valid paging occasion available in a given DRX cycle.

In response to determining that not every valid paging occasion collides with the at least one of the activities of the second subscription or the sleep period of the first subscription (B710:NO), the scheduling module 230 or the general-purpose processor 206 may set the at least one of the valid paging occasions to be the selected paging occasion at block B720. Illustrating with non-limiting examples, the selected paging occasion may be one or more of the first paging occasion, second paging occasion, or the like.

On the other hand, in response to determining that every valid paging occasion collides with the at least one of the activities of the second subscription or sleep period of the first subscription (B710:YES), the scheduling module 230 or the general-purpose processor 206 may abandon the CDRX mode with respect to the first subscription, at block B730. That is, the scheduling module 230 or the general-purpose processor 206 may configure the first subscription of wake up from the sleep period of the first subscription in at least the given DRX cycle so that the DRX cycle no longer include a sleep period that can collide with the emergency-related pages on the first subscription in the DRX cycle.

At block B740, the scheduling module 230 or the general-purpose processor 206 may determine the selected paging occasion based on the activities of the second subscription, for at least the DRX cycle. Given that the sleep period of the first subscription is no longer present in the DRX cycle, the sleep period of the first subscription may not need to be considered at block B740. The selected paging occasion for the DRX cycle may be a valid paging occasion closest to the designated paging occasion that does not collide with the activities of the second subscription.

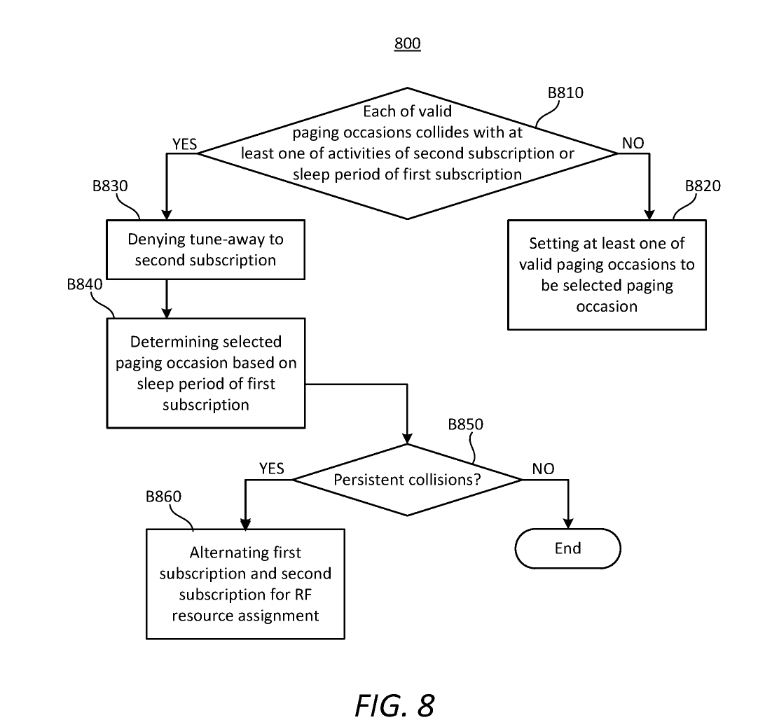

FIG. 8 is a process flow diagram illustrating a scheduling method 800 according to various examples. Referring to FIGS. 1-9, the scheduling method 800 shows an example of a particular aspect of the scheduling method 300. Specifically, block B320 may include blocks B810-B860 in some examples. The scheduling method 800 is concerned with denying tune-aways to the second subscription in response to determining that every valid paging occasion in a DRX cycle collides with the activities of the second subscription or the sleep period of the first subscription.

At block B810, the scheduling module 230 or the general-purpose processor 206 may determine whether each of the valid paging occasions collides with at least one of the activities of the second subscription or the sleep period of the first subscription. In some examples, the determination at block B810 may be made with respect to every valid paging occasion available in a given DRX cycle.

In response to determining that not every valid paging occasion collides with the at least one of the activities of the second subscription or the sleep period of the first subscription (B810:NO), the scheduling module 230 or the general-purpose processor 206 may set the at least one of the valid paging occasions to be the selected paging occasion at block B820. Illustrating with non-limiting examples, the selected paging occasion may be one or more of the first paging occasion, second paging occasion, or the like.

On the other hand, in response to determining that every valid paging occasion collides with the at least one of the activities of the second subscription or the sleep period of the first subscription (B810:YES), the scheduling module 230 or the general-purpose processor 206 may deny tune-away to the second subscription in the DRX cycle. The tune-away to the second subscription corresponds to the activities of the second subscription. Illustrating with a non-limiting example, the tune-away to the second subscription may be denied by assigning the first subscription a higher priority for usage of the RF resource 218 over the second subscription in at least the DRX cycle. Thus, when the first subscription and the second subscription contend for the RF resource 218, the first subscription may prevail even as the first subscription is in the RRC-connected state and the second subscription is in the RRC-idle state.

Illustrating with another non-limiting example, the tune-away to the second subscription may be denied by setting the first subscription to be in the RRC-idle state, so that both the first subscription and the second subscription may be in the RRC-idle state. An internal Radio Link Failure (RLF) may be triggered by the scheduling module 230 or the general-purpose processor 206 with respect to the first subscription. Under such conditions, if the first subscription and the second subscription contend for the RF resource 218, the first subscription may prevail. In some configurations, the internal RLF may be triggered as a response to determining that every valid paging occasion collides with the at least one of the activities of the second subscription or the sleep period of the first subscription in a given DRX cycle. In other configurations, the internal RLF may be triggered as a response to determining that every valid paging occasion collides with the at least one of the activities of the second subscription or the sleep period of the first subscription in one or more DRX cycles occurring before the given DRX cycle.

At block B840, the scheduling module 230 or the general-purpose processor 206 may determine the selected paging occasion based on the sleep period of the first subscription. Given that tuning aways to the second subscription is denied, the activities of the second subscription may not need to be considered at block B840. The selected paging occasion for the DRX cycle may be a valid paging occasion closest to the designated paging occasion that does not collide with the sleep period of the first subscription.

At block B850, the scheduling module 230 or the general-purpose processor 206 may determine whether the collisions are persistent in at least one subsequent DRX cycle. That is, the scheduling module 230 or the general-purpose processor 206 may determine whether every valid paging occasion collides with the at least one of the activities of the second subscription or the sleep period of the first subscription in at least one subsequent DRX cycle. This may occur as the DRX period of both subscriptions are multiples of one another. In response to determining that the collisions are not persistent (B850:NO), the method 800 ends.

On the other hand, in response to determining that the collisions are persistent (B850:YES), the scheduling module 230 or the general-purpose processor 206 may alternate the first subscription and the second subscription for RF resource assignment in the at least one subsequent DRX cycle. Illustrating with a non-limiting example in which the first subscription is granted higher priority for usage of the RF resource 218 in the given DRX cycle corresponding to at least the emergency-related pages, the second subscription may be granted priority for usage of the RF resource 218 in a following DRX cycle. In this manner, the second subscription may be granted an opportunity to decode pages when persistent collisions are occurring.

In further examples, the methods 700 and 800 may be used in combination (e.g., in an alternating fashion) to schedule activities of the first and second subscription for two or more DRX cycles. For example, in a first DRX cycle, blocks B730 and B740 may be executed in response to determining that each of the valid paging occasions collides with at least one of the activities of the second subscription or the sleep period of the first subscription (B710:YES). In a second DRX cycle that is subsequent to the DRX cycle, blocks B830 and B840 may be executed in response to determining that each of the valid paging occasions collides with at least one of the activities of the second subscription or the sleep period of the first subscription (B810:YES). To that effect, blocks B850 and B860 may not be needed given that blocks B730 and B740 allow for tune-aways to the second subscription.

The examples pertaining to the CDRX sleep can be extended to network-configured gaps in which the wireless communication device 200 (or a modem associated therewith) is forced to turn off the RF resource 218 to use the RF resource 218 for scanning other frequencies/cells on the same subscription/SIM. All details illustrated herein that involve CDRX sleep can be likewise applicable to the network-configured gaps.

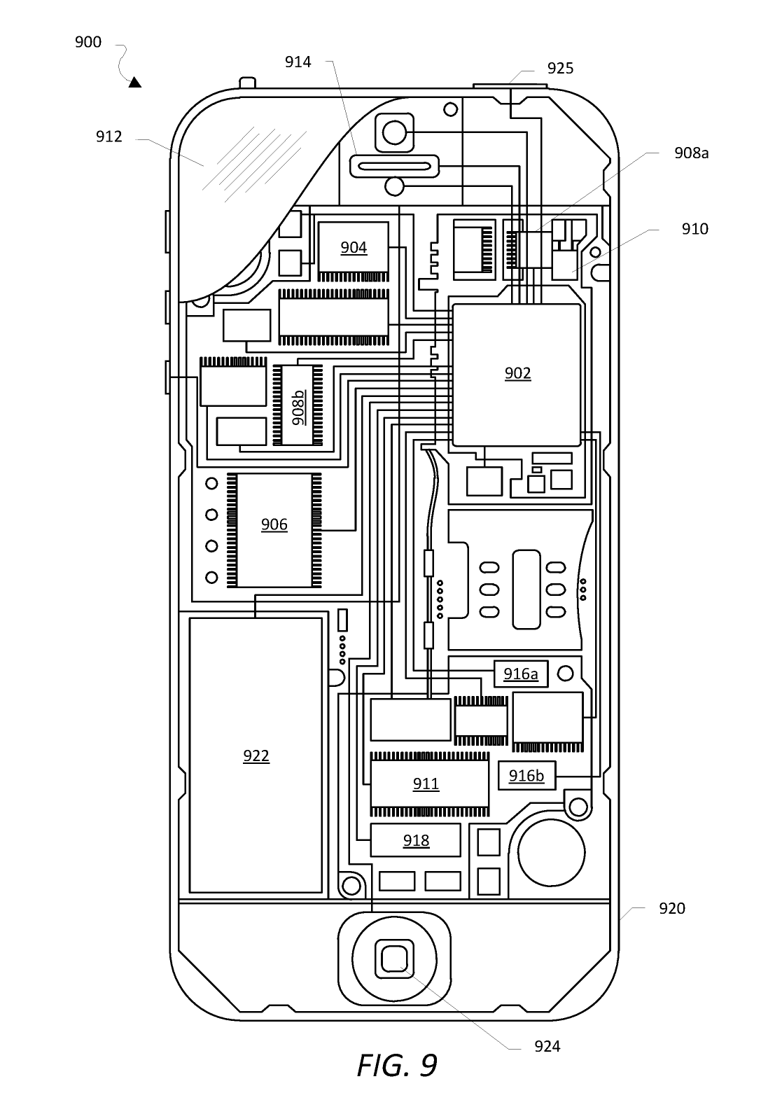

The various examples may be implemented in any of a variety of wireless communication devices 110 and 200, an example of which is illustrated in FIG. 9, as a wireless communication device 900. As such, the wireless communication device 900 may implement the process and/or the apparatus of FIGS. 1-8, as described herein.

With reference to FIGS. 1-9, the wireless communication device 900 may include a processor 902 coupled to a touchscreen controller 904 and an internal memory 906. The processor 902 may be one or more multi-core integrated circuits designated for general or specific processing tasks. The memory 906 may be volatile or non-volatile memory, and may also be secure and/or encrypted memory, or unsecure and/or unencrypted memory, or any combination thereof. The touchscreen controller 904 and the processor 902 may also be coupled to a touchscreen panel 912, such as a resistive-sensing touchscreen, capacitive-sensing touchscreen, infrared sensing touchscreen, etc. Additionally, the display of the wireless communication device 900 need not have touch screen capability.

The wireless communication device 900 may have one or more cellular network transceivers 908a, 908b coupled to the processor 902 and to at least one antenna 910 and configured for sending and receiving cellular communications. The transceivers 708a, 908b and antenna 910 may be used with the above-mentioned circuitry to implement the various example methods. The cellular network transceivers 908a, 908b may be the RF resource 218. The antenna 910 may be the antenna 220. The wireless communication device 900 may include two or more SIM cards 916a, 916b, corresponding to SIM-1 204a and SIM-2 204b (respectively), coupled to the transceivers 908a, 908b and/or the processor 902. The wireless communication device 900 may include a cellular network wireless modem chip 911 (e.g., the baseband modem processor 216) that enables communication via at least one cellular network and is coupled to the processor 902.

The wireless communication device 900 may include a peripheral device connection interface 918 coupled to the processor 902. The peripheral device connection interface 918 may be singularly configured to accept one type of connection, or multiply configured to accept various types of physical and communication connections, common or proprietary, such as USB, FireWire, Thunderbolt, or PCIe. The peripheral device connection interface 918 may also be coupled to a similarly configured peripheral device connection port (not shown).

The wireless communication device 900 may also include speakers 914 for providing audio outputs. The wireless communication device 900 may also include a housing 920, constructed of a plastic, metal, or a combination of materials, for containing all or some of the components discussed herein. The wireless communication device 900 may include a power source 922 coupled to the processor 902, such as a disposable or rechargeable battery. The rechargeable battery may also be coupled to a peripheral device connection port (not shown) to receive a charging current from a source external to the wireless communication device 900. The wireless communication device 900 may also include a physical button 924 for receiving user inputs. The wireless communication device 900 may also include a power button 926 for turning the wireless communication device 900 on and off.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the steps of various examples must be performed in the order presented. As will be appreciated by one of skill in the art the order of steps in the foregoing examples may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary examples, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present invention. Various modifications to these examples will be readily apparent to those skilled in the art, and the generic principles defined herein may be applied to some examples without departing from the spirit or scope of the invention. Thus, the present invention is not intended to be limited to the examples shown herein but is to be accorded the widest scope consistent with the following claims and the principles and novel features disclosed herein.

What is claimed is:

1. A method for a wireless communication device having a first Subscriber Identity Module (SIM) associated with a first subscription and a second SIM associated with a second subscription to manage communications over the first subscription and the second subscription, the method comprising:
determining valid paging occasions associated with the first subscription;
determining a selected paging occasion of the valid paging occasions based on at least one of activities of the second subscription or a sleep period of the first subscription; and
receiving a page of the first subscription on the selected paging occasion.

2. The method of claim 1, wherein the valid paging occasions associated with the first subscription are determined based on one or more of International Mobile Subscriber Identity (IMSI), length of a Discontinuous Reception (DRX) cycle, number of channels, or network parameters received from a first mobile network associated with the first subscription.

3. The method of claim 1, wherein determining the valid paging occasions associated with the first subscription comprises:
receiving the valid paging occasions from a first mobile network associated with the first subscription; and
storing the valid paging occasions.

4. The method of claim 1, wherein the valid paging occasions are determined in response to completing registration to a first mobile network associated with the first subscription.

5. The method of claim 1, wherein determining the selected paging occasion of the valid paging occasions based on at least one of the activities of the second subscription or the sleep period of the first subscription comprises determining a first paging occasion of the valid paging occasions based on the activities of the second subscription.

6. The method of claim 5, wherein determining the first paging occasion comprises:
determining the activities of the second subscription; and
selecting the first paging occasion from the valid paging occasions, wherein the first paging occasion avoids the activities of the second subscription.

7. The method of claim 5, further comprising:
determining a designated paging occasion, wherein the designated paging occasion is one of the valid paging occasions; and
determining that the designated paging occasion collides with the activities of the second subscription, wherein the first paging occasion is a paging occasion closest to the designated paging occasion that avoids the activities of the second subscription.

8. The method of claim 7, wherein the first paging occasion is a paging occasion closest to the designated paging occasion that avoids the activities of the second subscription in a same Discontinuous Reception (DRX) cycle.

9. The method of claim 5, wherein determining the selected paging occasion of the valid paging occasions based on at least one of the activities of the second subscription or the sleep period of the first subscription further comprises determining a second paging occasion of the valid paging occasions based on the sleep period of the first subscription.

10. The method of claim 9, wherein determining the second paging occasion comprises selecting the second paging occasion from the valid paging occasions, wherein the second paging occasion avoids the sleep period of the first subscription and the activities of the second subscription.

11. The method of claim 9, wherein the second paging occasion is a paging occasion closest to the first paging occasion that avoids the sleep period of the first subscription.

12. The method of claim 11, wherein the second paging occasion is a paging occasion closest to the first paging occasion that avoids the sleep period of the first subscription in a same Discontinuous Reception (DRX) cycle.

13. The method of claim 9, wherein the sleep period is a Connected Discontinuous Reception (CDRX) sleep period.

14. The method of claim 1, wherein the selected paging occasion is determined for every Discontinuous Reception (DRX) cycle.

15. The method of claim 1, wherein the page of the first subscription comprises an emergency-related page.

16. The method of claim 15, wherein the emergency-related page is related to one or more of Tsunami Warning Service (ETWS) or Commercial Mobile Alert System (CMAS).

17. The method of claim 1, wherein the first subscription is associated with active data transfer.

18. The method of claim 1, wherein:
the first subscription is a Long Term Evolution (LTE) subscription; and
the second subscription is a LTE subscription, Wideband Code Division Multiple Access (WCDMA) subscription, Global System for Mobile Communications (GSM) subscription, or Code Division Multiple Access 1× Radio Transmission Technology (1×) subscription.

19. The method of claim 1, wherein:
the first subscription is in a Radio Resource Control (RRC)-connected state; and
the second subscription is in a RRC-idle state.

20. A wireless communication device, comprising:
at least one radio frequency (RF) resource;
a processor configured to connect to a first Subscriber Identity Module (SIM) associated with a first subscription and to a second SIM associated with a second subscription, and configured with processor-executable instructions to:
determine valid paging occasions associated with the first subscription;
determine a selected paging occasion of the valid paging occasions based on at least one of activities of the second subscription or a sleep period of the first subscription; and
receive a page of the first subscription on the selected paging occasion; and
a memory.

21. The wireless communication device of claim 20, wherein the processor determines the selected paging occasion of the valid paging occasions based on at least one of the activities of the second subscription or the sleep period of the first subscription by determining a first paging occasion of the valid paging occasions based on the activities of the second subscription.

22. The wireless communication device of claim 21, wherein the processor determines the first paging occasion by:
determining the activities of the second subscription; and
selecting the first paging occasion from the valid paging occasions, wherein the first paging occasion avoids the activities of the second subscription.

23. The wireless communication device of claim 21, wherein the processor is further configured to:
determine a designated paging occasion, wherein the designated paging occasion is one of the valid paging occasions; and
determine that the designated paging occasion collides with the activities of the second subscription, wherein the first paging occasion is a paging occasion closest to the designated paging occasion that avoids the activities of the second subscription.

24. The wireless communication device of claim 23, wherein the first paging occasion is a paging occasion closest to the designated paging occasion that avoids the activities of the second subscription in a same Discontinuous Reception (DRX) cycle.

25. The wireless communication device of claim 21, wherein the processor determines the selected paging occasion of the valid paging occasions based on at least one of the activities of the second subscription or the sleep period of the first subscription further by determining a second paging occasion of the valid paging occasions based on the sleep period of the first subscription.

26. The wireless communication device of claim 25, wherein the processor determines the second paging occasion by selecting the second paging occasion from the valid paging occasions, wherein the second paging occasion avoids the sleep period of the first subscription and the activities of the second subscription.

27. The wireless communication device of claim 25, wherein the second paging occasion is a paging occasion closest to the first paging occasion that avoids the sleep period of the first subscription.

28. The wireless communication device of claim 27, wherein the second paging occasion is a paging occasion closest to the first paging occasion that avoids the sleep period of the first subscription in a same Discontinuous Reception (DRX) cycle.

29. A method for a wireless communication device having a first Subscriber Identity Module (SIM) associated with a first subscription and a second SIM associated with a second subscription to manage communications over the first subscription and the second subscription, the method comprising:
determining valid paging occasions associated with the first subscription;
determining activities of the second subscription;
determining a sleep period of the first subscription;
selecting a first set of at least one paging occasion from the valid paging occasions based on the activities of the second subscription;
selecting a second set of at least one paging occasion from the first set based on the sleep period of the first subscription; and
determining a selected paging occasion from the second set to receive a page of the first subscription.

30. A wireless communication device, comprising:
at least one radio frequency (RF) resource;
a processor configured to connect to a first Subscriber Identity Module (SIM) associated with a first subscription and to a second SIM associated with a second subscription, and configured with processor-executable instructions to:
determine valid paging occasions associated with the first subscription;
determine activities of the second subscription;
determine a sleep period of the first subscription;
select a first set of at least one paging occasion from the valid paging occasions based on the activities of the second subscription;
select a second set of at least one paging occasion from the first set based on the sleep period of the first subscription; and
determine a selected paging occasion from the second set to receive a page of the first subscription; and
a memory.

31. The method of claim 1, wherein determining the selected paging occasion of the valid paging occasions based on the at least one of the activities of the second subscription or the sleep period of the first subscription comprises:
determining that each of the valid paging occasions collides with the at least one of the activities of the second subscription or the sleep period of the first subscription;
abandoning a Connected Discontinuous Reception (CDRX) mode with respect to the first subscription; and
determining the selected paging occasion of the valid paging occasions based on the activities of the second subscription.

32. The method of claim 31, wherein each of the valid paging occasions is determined to be colliding with the at least one of the activities of the second subscription or the sleep period of the first subscription in a Discontinuous Reception (DRX) cycle.

33. The method of claim 31, wherein abandoning the CDRX mode with respect to the first subscription comprises waking up from the sleep period of the first subscription in a Discontinuous Reception (DRX) cycle.

34. The method of claim 1, wherein determining the selected paging occasion of the valid paging occasions based on the at least one of the activities of the second subscription or the sleep period of the first subscription comprises:
determining that each of the valid paging occasions collides with the at least one of the activities of the second subscription or the sleep period of the first subscription;
denying tune-away to the second subscription that corresponds to the activities of the second subscription; and
determining the selected paging occasion of the valid paging occasions based on the sleep period of the first subscription.

35. The method of claim 34, wherein the tune-away to the second subscription is denied by assigning the first subscription to have priority for usage of Radio Frequency (RF) resource over the second subscription.

36. The method of claim 34, wherein the tune-away to the second subscription is denied by setting the first subscription to be in a RRC-idle state.

37. The method of claim 34, wherein the tune-away to the second subscription is denied in a Discontinuous Reception (DRX) cycle.

38. The method of claim 37, further comprising:
determining that each of the valid paging occasions collides with the at least one of the activities of the second subscription or the sleep period of the first subscription in at least one subsequent DRX cycle; and
alternating the first subscription and the second subscription for Radio Frequency (RF) resource assignment.
